(19) United States
(12) Patent Application Publication
(10) Pub. No.: US 2026/0351876 A1
(43) Pub. Date: Nov. 5, 2026

(54) CONNECTOR ASSEMBLY, BOARD END CONNECTOR AND CABLE END CONNECTOR

(71) Applicant: Bellwether Electronic Corp., Taoyuan City (TW)

(72) Inventors: Yung-Liang CHI, Taoyuan City (TW); Chia Ming LEE, Taoyuan City (TW)

(21) Appl. No.: 19/277,368

(22) Filed: Jul. 22, 2025

(30) Foreign Application Priority Data
May 2, 2025 (TW) 114116655

(51) Int. Cl. H01R 12/71; H01R 12/75; H01R 13/514

(52) U.S. Cl. CPC H01R 12/716; H01R 12/75; H01R 13/514

(57) ABSTRACT

A connector assembly includes a first connector and a second connector. The first connector includes a first housing and a board end terminal set locating in a slot of the first housing and including a pair of board end terminals respectively including a connecting portion located in the slot and a mating portion connecting the connecting portion and having a folded structure. The second connector includes a second housing, a mating piece, a pair of cable end terminals and a cable set. The mating piece extends from the second housing. The cable end terminals are disposed on opposite sides of the mating piece. The cable set includes a pair of cables connecting the cable end terminals and passing through and extending outwardly from the second housing. The mating piece inserts between the mating portions, such that the board end terminals connect the cable end terminals.

### CROSS-REFERENCE TO RELATED APPLICATION

This application claims priority to Taiwanese Application Serial Number 114116655, filed May 2, 2025, which is herein incorporated by reference in its entirety.

### BACKGROUND

### Field of Invention

The present disclosure relates to connector assemblies, each of which includes a board end connector and a cable end connector connected to each other.

### Description of Related Art

As the pace of modern life continues to accelerate, the demand for electronic devices has been steadily increasing. Facing a huge consumer market, manufacturers are not only focused on enhancing the functionality and performance of their products but also striving to improve the reliability and stability of electronic devices in order to boost the market competitiveness of their brands.

Taking power connectors as an example, the measure to effectively reduce their size to save space while ensuring more reliable connections between electronic devices at a low cost is undoubtedly an important issue of concern to the industry.

### SUMMARY

A technical aspect of the present disclosure is to provide a connector assembly, which can effectively reduce the overall height of the connector assembly along the mating direction after the board end connector and the cable end connector are connected, leading to a saving of space and enhancing the practicality of the connector assembly.

According to an embodiment of the present disclosure, a connector assembly includes a first connector and a second connector. The first connector includes a first insulating housing and at least one first board end terminal set. The first insulating housing has a slot. The first board end terminal set is at least partially located in the slot. The first board end terminal set includes a pair of first board end terminals. The first board end terminals include a connecting portion and a mating portion. The connecting portion is located in the slot and at least partially exposed out of the first insulating housing so as to electrically connect with a printed circuit board. The mating portion is connected with the connecting portion. The mating portion has a folded structure. The mating portion is located in the slot and spaced apart from the mating portion of another one of the first board end terminals. The second connector includes a second insulating housing, a plate-shaped mating piece, at least a pair of first cable end terminals and a cable set. The second insulating housing has a mating surface. The plate-shaped mating piece extends from the mating surface along a mating direction. The first cable end terminals are disposed at two opposite sides of the plate-shaped mating piece. The first cable end terminals are electrically insulated from each other. The cable set includes at least a pair of cables. The cables are respectively and electrically connected with a corresponding one of the first cable end terminals. The cables pass through and extend outwardly from the second insulating housing. The plate-shaped mating piece is configured to insert between the mating portions along the mating direction, such that the first board end terminals of the first board end terminal set are respectively and electrically connected with a corresponding one of the first cable end terminals.

In one or more embodiments of the present disclosure, the mating portion of each of the first board end terminals includes a plurality of elastic arms. The elastic arms are spaced apart from each other and respectively connected with the connecting portion.

In one or more embodiments of the present disclosure, each of the elastic arms has a first end and a second end. The first end is connected with the connecting portion. The second end is a free end. A height of the second end along the mating direction is lower than or equal to a height of the first end along the mating direction.

In one or more embodiments of the present disclosure, the first insulating housing has an opening and at least one avoidance space communicated with the opening. The opening and the avoidance space are communicated with the slot. The plate-shaped mating piece and the first cable end terminals together define a cross-section. A profile of the cross-section matches with a profile of the opening and the avoidance space. The plate-shaped mating piece is configured to at least partially pass through the opening and the avoidance space.

In one or more embodiments of the present disclosure, each of two lateral edges of the plate-shaped mating piece is shaped as a bar column.

In one or more embodiments of the present disclosure, each of the first cable end terminals is at least partially exposed from a surface of the plate-shaped mating piece to form an exposed portion. The exposed portion is shaped as a rectangular flat plate. A length of the exposed portion along the mating direction is shorter than a length of the exposed portion perpendicular to the mating direction.

In one or more embodiments of the present disclosure, the second insulating housing includes a main portion and a wall portion. The main portion has the mating surface. The mating surface is configured to at least partially abut against the first insulating housing. The wall portion is connected with the main portion. The wall portion at least partially surrounds the plate-shaped mating piece to define an inner profile and a space. The plate-shaped mating piece is located in the space. The first insulating housing is configured to at least partially insert into the space and abut against the main portion. The first insulating housing defines an outer profile. The outer profile and the inner profile are respectively and at least partially asymmetrical. The outer profile and the inner profile match with each other.

According to an embodiment of the present disclosure, a board end connector includes an insulating housing and a plurality of first board end terminals. The insulating housing has a slot and a plurality of isolating walls. The isolating walls are located at two opposite long sides of the slot to define a plurality of subsidiary slots communicated with each other. The first board end terminals are fixed in the insulating housing and respectively located in a corresponding one of the subsidiary slots.

In one or more embodiments of the present disclosure, a width of at least one of the isolating walls is larger than a width of at least another one of the isolating walls.

In one or more embodiments of the present disclosure, the board end connector further includes at least one second board end terminal. One of the isolating walls with a larger width has at least one signal slot. The second board end terminal is located in the signal slot.

In one or more embodiments of the present disclosure, the slot further defines at least one foolproof groove communicated with the subsidiary slots.

In one or more embodiments of the present disclosure, each of the first board end terminals has a connecting portion and a mating portion. The mating portion is connected with the connecting portion. The connecting portion is configured to connect with a circuit board. The mating portion is at least partially located in a corresponding one of the subsidiary slots. The mating portion includes a plurality of elastic arms. The elastic arms are spaced apart from each other.

In one or more embodiments of the present disclosure, each of the elastic arms is a folded structure and includes an outer subsidiary elastic arm and an inner subsidiary elastic arm. The inner subsidiary elastic arm is located at an inner side of the outer subsidiary elastic arm. The inner subsidiary elastic arm is configured to contact with an electric element inserting into the slot.

In one or more embodiments of the present disclosure, the insulating housing includes a snap-fit structure. The snap-fit structure is located at two opposite short side edges of the insulating housing. The snap-fit structure is configured to snap with a snapping portion of a mating connector.

According to an embodiment of the present disclosure, a cable end connector includes an insulating housing, a plate-shaped mating piece and a plurality of first cable end terminals. The insulating housing has a mating surface. The plate-shaped mating piece extends from the mating surface along a mating direction. The first cable end terminals are disposed at two opposite sides of the plate-shaped mating piece. The first cable end terminals are electrically insulated from each other. Each of the first cable end terminals is at least partially exposed from a surface of the plate-shaped mating piece to form an exposed portion. The exposed portion is shaped as a rectangular flat plate. A length of the exposed portion along the mating direction is shorter than a length of the exposed portion perpendicular to the mating direction.

In one or more embodiments of the present disclosure, the cable end connector further includes at least one second cable end terminal. The second cable end terminal is disposed on the plate-shaped mating piece and is at least partially exposed from the plate-shaped mating piece. A distance between a distal end of the second cable end terminal and the mating surface is shorter than a distance between a distal end of each of the first cable end terminals and the mating surface.

In one or more embodiments of the present disclosure, a width of the second cable end terminal perpendicular to the mating direction is shorter than a width of each of the first cable end terminals perpendicular to the mating direction.

The above-mentioned embodiments of the present disclosure have at least the following advantages:
(1) Since a height of each of the mating portions of the first board end terminals along the second direction is reduced because of its folded structure, the height of the first insulating housing along the second direction relative to the printed circuit board can be effectively reduced. Thus, the overall height of the connector assembly along the second direction can be significantly reduced, which leads to a saving of space and enhances the practicality of the connector assembly.
(2) Since a profile of the cross-section of the plate-shaped mating piece matches with a profile of the opening and the avoidance space of the first insulating housing, this design is foolproof and can prevent incorrect assembly when the second connector is connected to the first connector.
(3) Since the second insulating housing of the second connector includes a main portion and a wall portion, while the outer profile of the first insulating housing of the first connector and the inner profile of the wall portion are respectively and at least partially asymmetrical and match with each other, this design is more foolproof and can further prevent incorrect assembly when the second connector is connected to the first connector.

### BRIEF DESCRIPTION OF THE DRAWINGS

The invention can be more fully understood by reading the following detailed description of the embodiment, with reference made to the accompanying drawings as follows:

FIG. 1 is a schematic view of a connector assembly according to an embodiment of the present disclosure;

FIG. 2 is a schematic view of the first connector of FIG. 1;

FIG. 3 is a regionally enlarged view of the first connector of FIG. 2, in which the first insulating housing is omitted;

FIGS. 4-5 are schematic views of the second connector of FIG. 1 in different perspectives;

FIG. 6 is a sectional view along the sectional line A-A of FIG. 1;

FIG. 7 is a sectional view along the sectional line B-B of FIG. 1;

FIG. 8 is a sectional view along the sectional line C-C of FIG. 1;

FIG. 9 is a schematic view of a connector assembly according to another embodiment of the present disclosure;

FIG. 10 is a sectional view along the sectional line D-D of FIG. 9;

FIG. 11 is a sectional view along the sectional line E-E of FIG. 9;

FIG. 12 is a schematic view of a connector assembly according to a further embodiment of the present disclosure; and

FIG. 13 is a schematic view of the connector assembly of FIG. 12, in which the first insulating housing and the second insulating housing are omitted.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

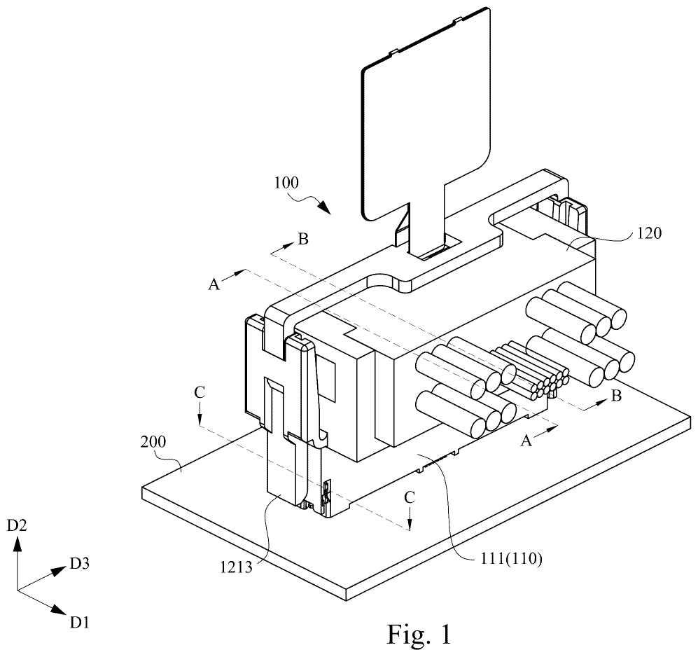

Reference is made to FIG. 1. FIG. 1 is a schematic view of a connector assembly 100 according to an embodiment of the present disclosure. In this embodiment, as shown in FIG. 1, a connector assembly 100 is provided in the present disclosure. The connector assembly 100 includes a first connector 110 and a second connector 120, which can be connected with each other. In practice, the first connector 110 is a board end connector, while the second connector 120 is a cable end connector.

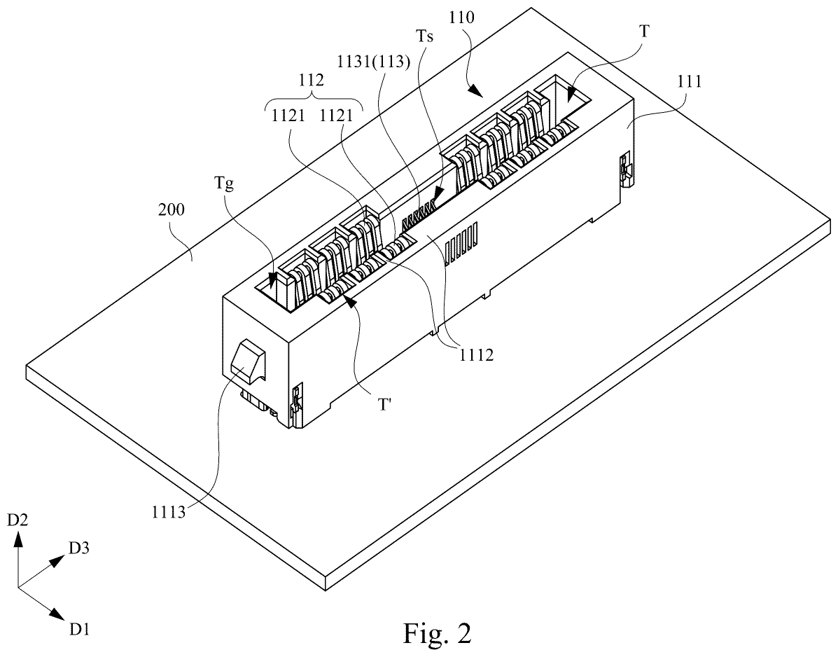

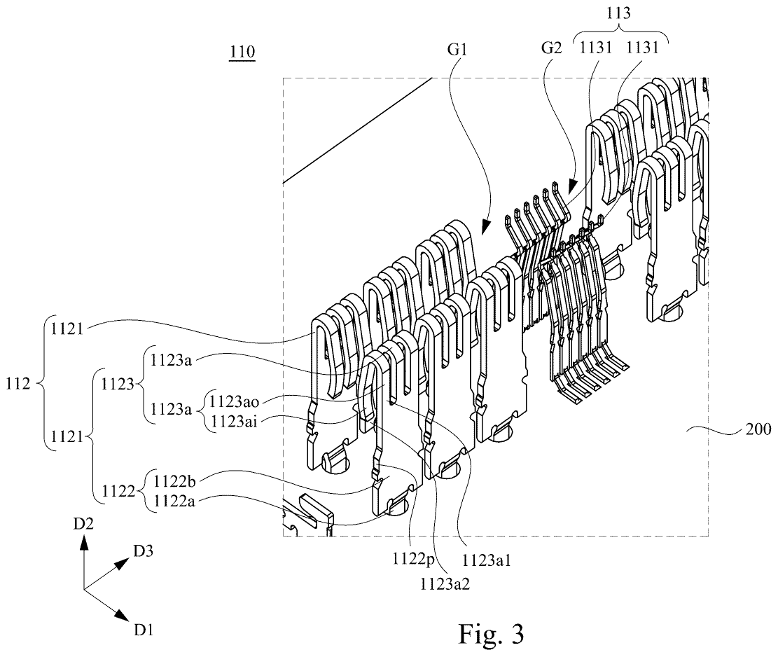

Reference is made to FIGS. 2-3. FIG. 2 is a schematic view of the first connector 110 of FIG. 1. FIG. 3 is a regionally enlarged view of the first connector 110 of FIG. 2, in which the first insulating housing 111 is omitted. In this embodiment, the first connector 110 includes a first insulating housing 111 and at least one first board end terminal set 112. The first insulating housing 111 of the first connector 110 is configured to connect with a printed circuit board 200, such that the first connector 110 is fixed on the printed circuit board 200. In practice, as shown in FIGS. 2-3, the first connector 110 further includes at least one second board end terminal set 113. The first board end terminal set 112 includes plural pairs of terminals, and the second board end terminal set 113 is located between adjacent two pairs of the terminals of the first board end terminal sets 112. The first insulating housing 111 has a slot T. The first board end terminal set 112 is at least partially located in (or exposed from) the slot T of the first insulating housing 111. Each of the first board end terminal sets 112 includes a pair of first board end terminals 1121. The first board end terminals 1121 respectively include a connecting portion 1122 and a mating portion 1123. Specifically speaking, the connecting portion 1122 is at least partially exposed out of the first insulating housing 111 to electrically connect with the printed circuit board 200. The mating portion 1123 is connected with the connecting portion 1122. The mating portion 1123 is located in (or exposed from) the slot T. The mating portion 1123 is spaced apart from the mating portion 1123 of another one of the first board end terminals 1121, i.e., the two opposite mating portions 1123 form a first gap G1 therebetween.

Similarly, as shown in FIGS. 2-3, the second board end terminal set 113 is at least partially located in the slot T of the first insulating housing 111. The second board end terminal set 113 includes a pair of second board end terminals 1131. The second board end terminals 1131 are spaced apart from each other, i.e., the two opposite second board end terminals 1131 form a second gap G2 therebetween. To be more specific, the second board end terminals 1131 are at least partially exposed out of the first insulating housing 111 to electrically connect with the printed circuit board 200. As shown in FIG. 2, the first insulating housing 111 has a plurality of isolating walls 1112, and the isolating walls 1112 are located in the slot T. Moreover, two opposite long sides of the slot T define a plurality of subsidiary slots T′ (or known as terminal grooves) thereon. The subsidiary slots T′ are communicated with each other. Adjacent two of the subsidiary slots T′ are isolated from each other by one of the isolating walls 1112. In practice, a width of at least one of the isolating walls 1112 is larger than a width of at least another one of the isolating walls 1112. The isolating wall 1112 with a larger width can be known as a protruding portion. The protruding portion forms at least one signal slot Ts thereon. The signal slot Ts and the slot T are communicated with each other. The slot T further has a foolproof structure, such as a protrusion or a groove, so as to prevent incorrect assembly. In this embodiment, a side of the slot T defines at least one foolproof groove Tg. In some embodiments, the slot T has a plurality of the foolproof grooves Tg, and the foolproof grooves Tg can have different widths. In other embodiments, the slot T has the foolproof structures, such as the foolproof grooves Tg, on both sides. The first board end terminals 1121 and/or the second board end terminals 1131 can be installed on the foolproof structures.

Furthermore, as shown in FIGS. 2-3, a pair of the first board end terminals 1121 of each of the first board end terminal set 112 are arranged face-to-face along a first direction D1 or arranged in a staggered pattern, and each of the first board end terminals 1121 at least partially extends along a second direction D2. Moreover, the first board end terminal sets 112 are arranged along a third direction D3 to form two rows of the first board end terminals 1121. The first direction D1, the second direction D2 and the third direction D3 are perpendicular (i.e., orthogonal) to each other, and the second direction D2 is parallel with a normal direction of the printed circuit board 200. The second direction D2 is also a mating direction, i.e., the first connector 110 and the second connector 120 are connected with each other along the second direction D2. Therefore, as shown in FIG. 1, when the second connector 120 is connected with the first connector 110 disposed on the printed circuit board 200 along the second direction D2, the second connector 120 is perpendicularly connected with the first connector 110. The first board end terminals 1121 are respectively installed in the corresponding subsidiary slots T′. The first connector 110 and the second connector 120 respectively have corresponding snap-fit structures located on their two opposite short side edges. The snap-fit structures can be, for example, protruding blocks, grooves or snapping arms, such that the first connector 110 and the second connector 120 are snapped with each other when connected, so as to stabilize the relation and status of connection between each other. As shown in FIGS. 1-2, the first connector 110 has a plurality of protruding blocks 1113 located on two opposite short side edges of the first insulating housing 111, while the second connector 120 has a plurality of snapping arms 1213. In other embodiments, the first connector 110 has a plurality of snapping arms, while the second connector 120 has a plurality of protruding blocks or grooves.

To be specific, as shown in FIG. 3, each of the connecting portions 1122 includes a pin portion 1122a and a fixing portion 1122b connected with the pin portion 1122a. The pin portions 1122a are at least partially exposed out of the first insulating housing 111 to electrically connect with the printed circuit board 200. The fixing portions 1122b are respectively shaped as a flat plate and connected with a corresponding one of the pin portions 1122a. Each of the fixing portions 1122b has some protruded portions 1122p located at two sides, such that the fixing portions 1122b can be installed in the first insulating housing 111 by the manner of interference, and thus the first board end terminals 1121 can be fixed. In other words, the fixing portions 1122b are respectively disposed in the subsidiary slots T′. The protruded portions 1122p and the isolating walls 1112 are fixed with each other through interference fit. In the third direction D3, a width of the pin portion 1122a is smaller than a width of the fixing portion 1122b, and the pin portion 1122a is shifted inwards (i.e., towards a center of the slot T) relative to the fixing portion 1122b. Correspondingly, the mating portion 1123 includes a plurality of elastic arms 1123a. The elastic arms 1123a are arranged along the third direction D3 and spaced apart from each other. The elastic arms 1123a are respectively connected with a corresponding one of the fixing portions 1122b. In the third direction D3, a width of the mating portion 1123 (and the elastic arms 1123a) is smaller than a width of the fixing portion 1122b.

To be specific, as shown in FIG. 3, each of the elastic arms 1123a of the mating portion 1123 is a folded structure, which is roughly shaped as a reversed “U”. Each of the elastic arms 1123a has a first end 1123a1 and a second end 1123a2 opposite to the first end 1123a1. The first end 1123a1 is connected with a corresponding one of the fixing portions 1122b. The second end 1123a2 is a free end. In this way, the mating portion 1123 has certain elasticity relative to the connecting portion 1122. In the second direction D2, a height of the second end 1123a2 is lower than or equal to a height of the first end 1123a1. In other words, each of the elastic arms 1123a can be divided into an outer subsidiary elastic arm 1123ao and an inner subsidiary elastic arm 1123ai connected with the outer subsidiary elastic arm 1123ao. Each of the outer subsidiary elastic arms 1123ao is connected with the fixing portion 1122b. The inner subsidiary elastic arms 1123ai are respectively folded inwards (i.e., in a direction towards the center of the slot T) relative to the outer subsidiary elastic arms 1123ao and located at an inner side of the outer subsidiary elastic arms 1123ao. In some embodiments, the inner subsidiary elastic arms 1123ai are at least partially located at an inner side of the fixing portion 1122b. This means a projection of each of the inner subsidiary elastic arms 1123ai and a projection of the fixing portion 1122b at least partially overlap with each other along the first direction D1. Moreover, each of the inner subsidiary elastic arms 1123ai has an inwardly curved position which forms a contact zone. The contact zone is configured to connect with an electric element inserting into the slot T.

Moreover, as shown in FIGS. 2-3, a quantity of the second board end terminal set 113 is also plural. The second board end terminal sets 113 are independent of each other and arranged along the third direction D3. The second board end terminal sets 113 are located between two adjacent first board end terminal sets 112. To be specific, the second board end terminal sets 113 are respectively installed inside the corresponding signal slots Ts of the protruding portion. The second board end terminal sets 113 at least partially extend and are exposed from the slot T. A width (along the third direction D3) of each of the second board end terminals 1131 is shorter than a width of each of the first board end terminals 1121 or a width of each of the elastic arms 1123a. In this embodiment, each of the second board end terminals 1131 does not have a folded structure. In other embodiment, at least one of the second board end terminals 1131 has a folded structure.

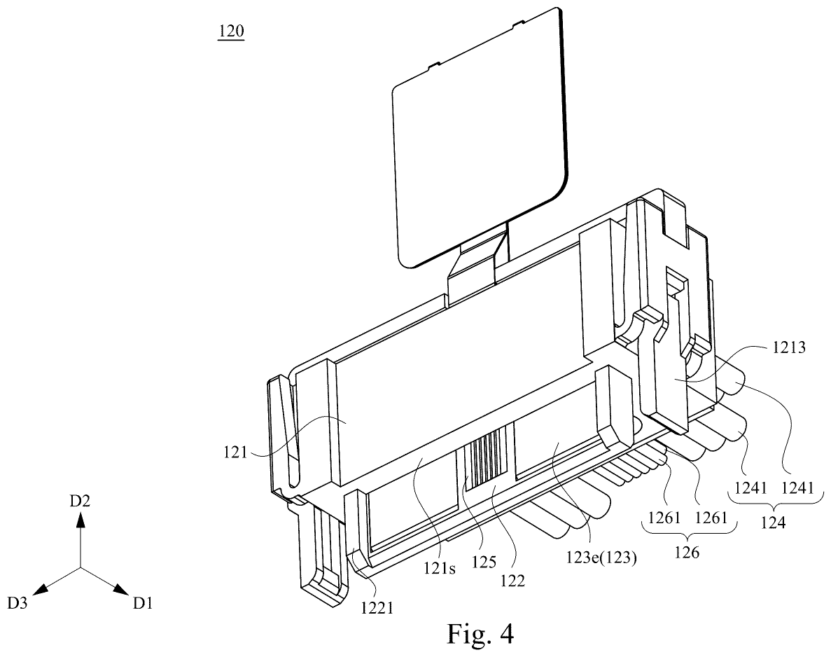

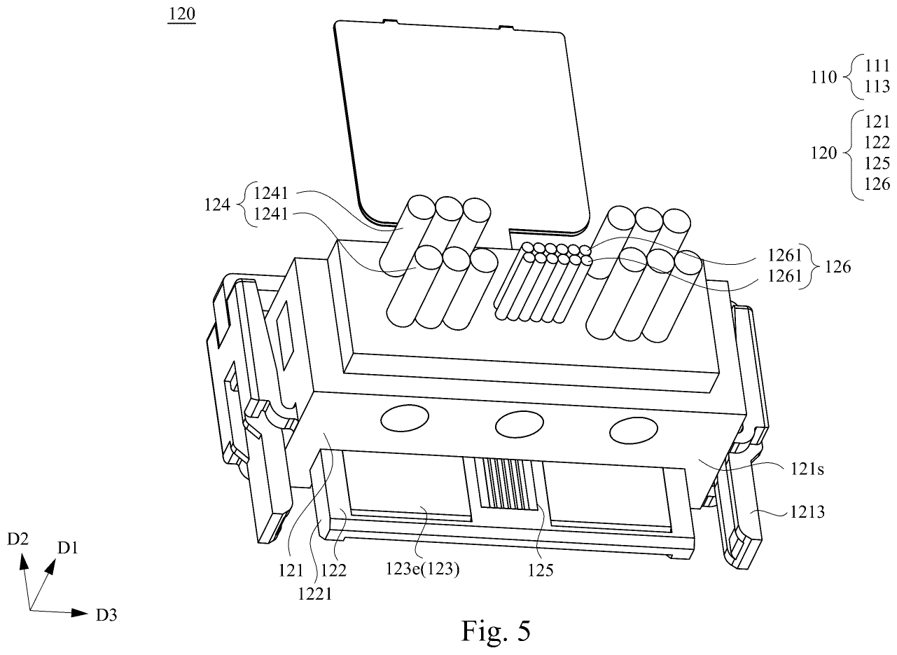

Reference is made to FIGS. 4-5. FIGS. 4-5 are schematic views of the second connector 120 of FIG. 1 in different perspectives. In this embodiment, as shown in FIGS. 4-5, the second connector 120 includes a second insulating housing 121, a plate-shaped mating piece 122, at least a pair of first cable end terminals 123 and a first cable set 124. In this embodiment, the second connector 120 further includes at least one second cable end terminal 125 and a second cable set 126. The plate-shaped mating piece 122 is connected with the second insulating housing 121 (may be also known as an insulating body) and extended outwardly from a surface (i.e., a mating surface 121s) of a side of the second insulating housing 121 so as to be exposed. The plate-shaped mating piece 122 is configured to insert into the slot T and to be located between the mating portions 1123 of the first board end terminals 1121. The first cable end terminals 123 are disposed at two opposite sides of the plate-shaped mating piece 122. The first cable end terminals 123 are electrically insulated from each other. Each of the first cable end terminals 123 is at least partially exposed from a surface of the plate-shaped mating piece 122 to form an exposed portion 123e. The exposed portion 123e is shaped as a rectangular flat plate. A length of the exposed portion 123e of each of the first cable end terminals 123 along the third direction D3 is longer than a length of the exposed portion 123e along the second direction D2. The first cable set 124 includes at least a pair of first cables 1241. The first cables 1241 are respectively and electrically connected with one corresponding first cable end terminal 123. The first cables 1241 passes through and extends outwardly from the second insulating housing 121. In this embodiment, the plate-shaped mating piece 122 at least partially extends along the second direction D2, while the first cable set 124 and the second cable set 126 at least partially extend along the first direction D1. The second cable end terminal 125 is disposed on at least one side of the plate-shaped mating piece 122, and the first cable end terminals 123 are staggered with each other. The second cable end terminal 125 is at least partially exposed from a surface of the plate-shaped mating piece 122 and extends along the second direction D2. This exposed portion is also shaped as a flat plate. The second cable set 126 includes at least one second cable 1261. The second cable 1261 is electrically connected with the second cable end terminal 125. The second cable 1261 passes through the second insulating housing 121. A length of the second cable end terminal 125 along the second direction D2 (i.e., the mating direction) is shorter than a length of the first cable end terminals 123 along the second direction D2. In other words, a distance between a distal end (an end away from the second insulating housing 121) of the second cable end terminal 125 and the mating surface 121s of the second insulating housing 121 is shorter than a distance between a distal end of the first cable end terminals 123 and the mating surface 121s of the second insulating housing 121. In the third direction D3, a width of the second cable end terminal 125 is shorter than a width of each of the first cable end terminals 123. The plate-shaped mating piece 122 can have a foolproof structure so as to prevent incorrect assembly. The fool proof structure of the plate-shaped mating piece 122 matches with the foolproof structure of the slot T, which can be a corresponding groove and a protrusion. In this embodiment, the foolproof structure of the plate-shaped mating piece 122 is, for example, the protrusions at two opposite edges of the plate-shaped mating piece 122. Each of the protrusions is a bar column 1221 at least partially extending along the second direction D2.

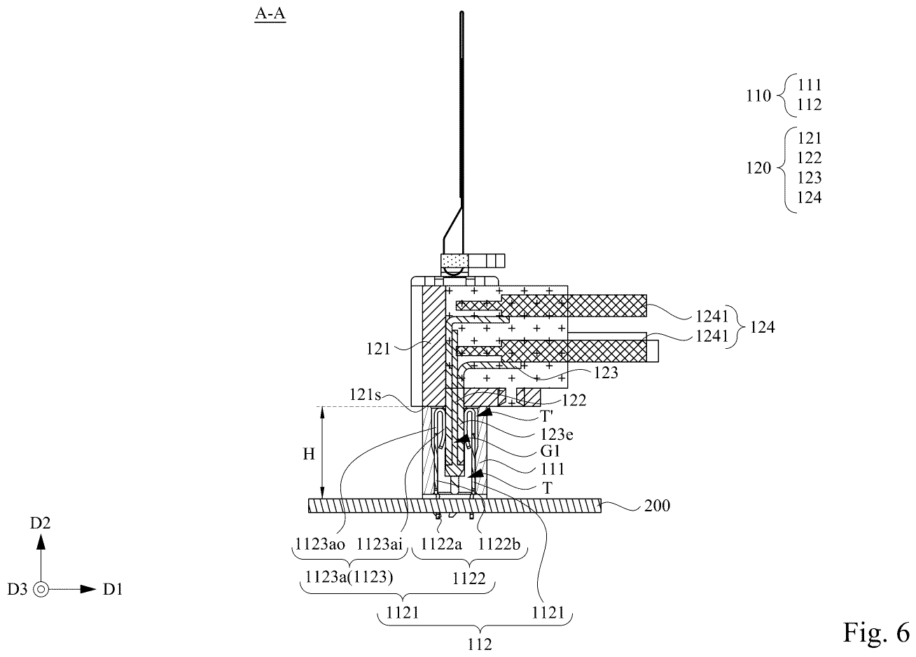

Reference is made to FIG. 6. FIG. 6 is a sectional view along the sectional line A-A of FIG. 1. In this embodiment, as shown in FIG. 6, when the second connector 120 is connected with the first connector 110, the second insulating housing 121 (i.e., the mating surface 121s of the second insulating housing 121) of the second connector 120 at least partially abuts against the first insulating housing 111 (i.e., the top surface of the first insulating housing 111) of the first connector 110, while the plate-shaped mating piece 122 of the second connector 120 inserts between the first board end terminals 1121 so as to be at least partially located in the first gap G1, such that the first cable end terminals 123 of the second connector 120 at least partially abut against and electrically connect with the mating portions 1123 of the first board end terminals 1121 respectively. In this embodiment, each of the first cable end terminals 123 is electrically connected with the first board end terminals 1121 of the first board end terminal sets 112.

It is worth to note that, as shown in FIG. 6, since a height of each of the mating portions 1123 of the first board end terminals 1121 along the second direction D2 is reduced because of its folded structure, the height H of the first insulating housing 111 along the second direction D2 relative to the printed circuit board 200 can be effectively reduced. Thus, the overall height of the connector assembly 100 along the second direction D2 can be significantly reduced, which leads to a saving of space and enhances the practicality of the connector assembly 100.

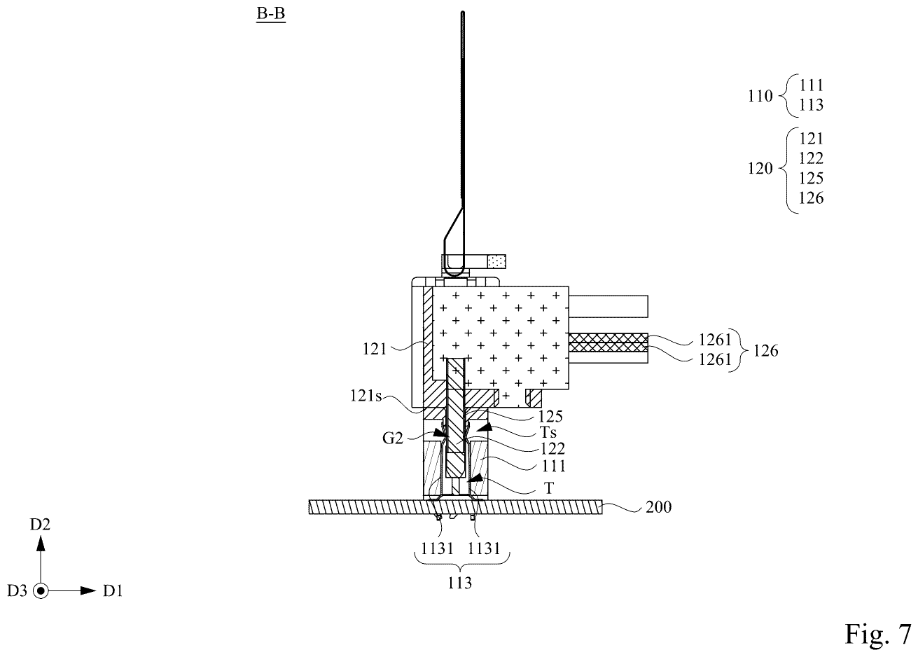

Reference is made to FIG. 7. FIG. 7 is a sectional view along the sectional line B-B of FIG. 1. In this embodiment, as shown in FIG. 7, when the second connector 120 is connected with the first connector 110, the plate-shaped mating piece 122 of the second connector 120 also inserts between the second board end terminals 1131. Thus, the plate-shaped mating piece 122 is at least partially located in the second gap G2, such that the second cable end terminals 125 are at least partially electrically connected with the second board end terminals 1131 respectively.

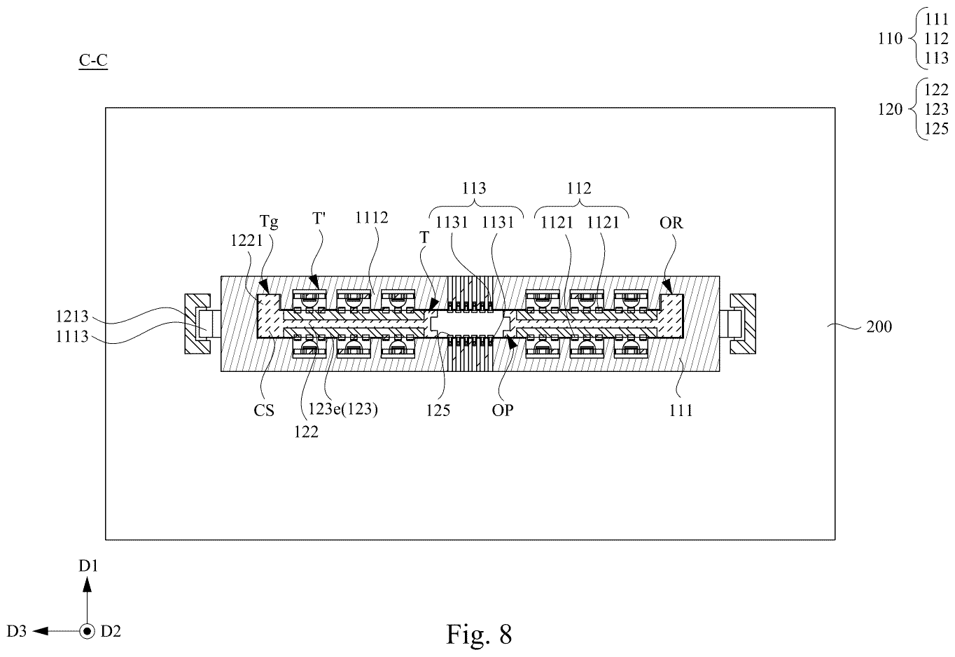

Reference is made to FIG. 8. FIG. 8 is a sectional view along the sectional line C-C of FIG. 1. In this embodiment, as shown in FIG. 8, the first insulating housing 111 of the first connector 110 has an opening OP and at least one avoidance space OR (i.e., the foolproof structure, which can be, for example, an opening) communicated with the opening OP. The avoidance space OR is, for example, an opening passing through the first insulating housing 111. The opening OP and the avoidance space OR are communicated with the slot T (including the subsidiary slots T′ and the foolproof grooves Tg). The plate-shaped mating piece 122 is configured to at least partially pass through the opening OP and the avoidance space OR, such that the plate-shaped mating piece 122 is inserted between the first board end terminals 1121 and between the second board end terminals 1131. Correspondingly, the plate-shaped mating piece 122 of the second connector 120, the first cable end terminals 123 and the second cable end terminals 125 together define a cross-section CS (i.e., the foolproof structure of the second connector 120), while the cross-section CS is perpendicular to the second direction D2. A profile of the cross-section CS matches with a profile of the opening OP and the avoidance space OR, this design is foolproof and can prevent incorrect assembly when the second connector 120 is connected to the first connector 110.

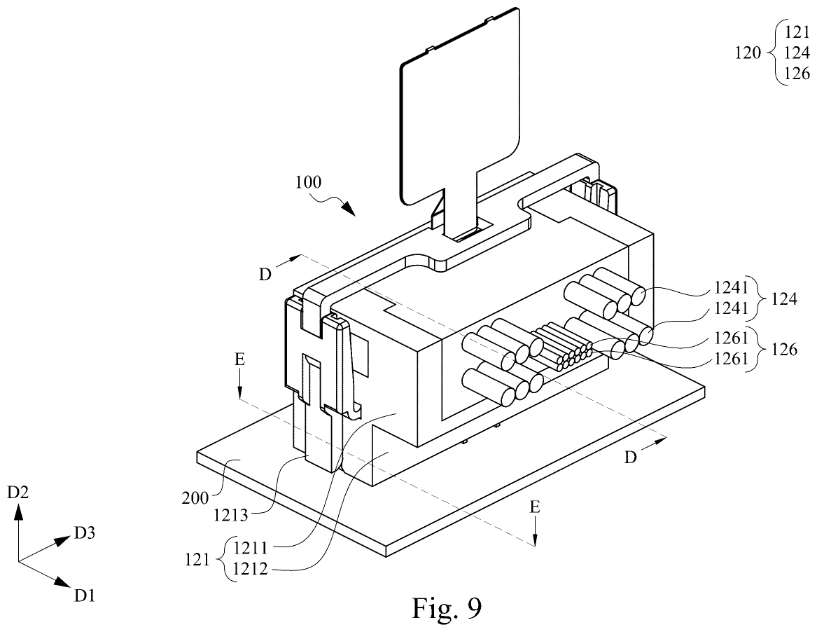

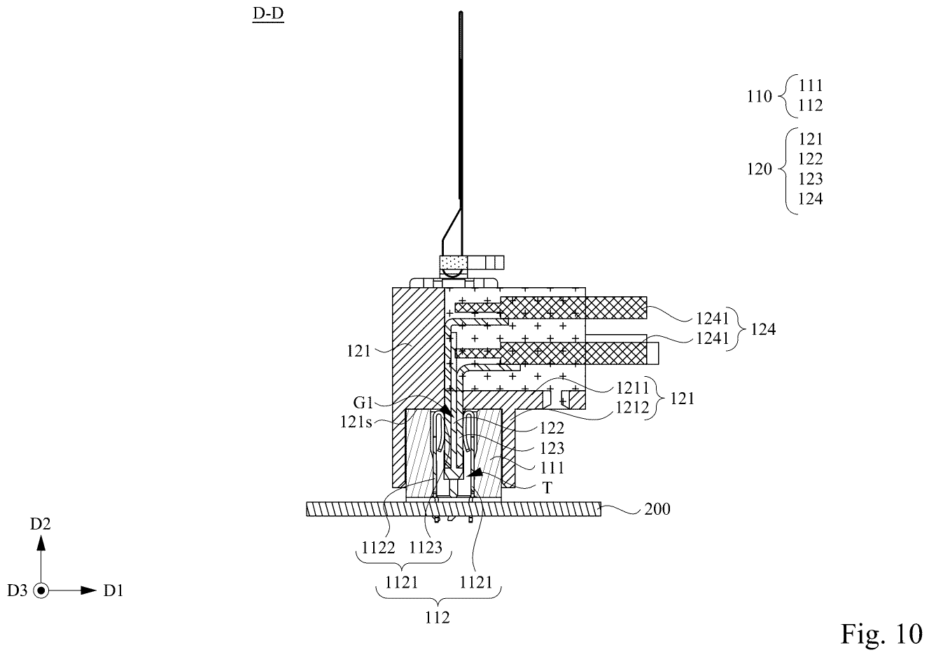

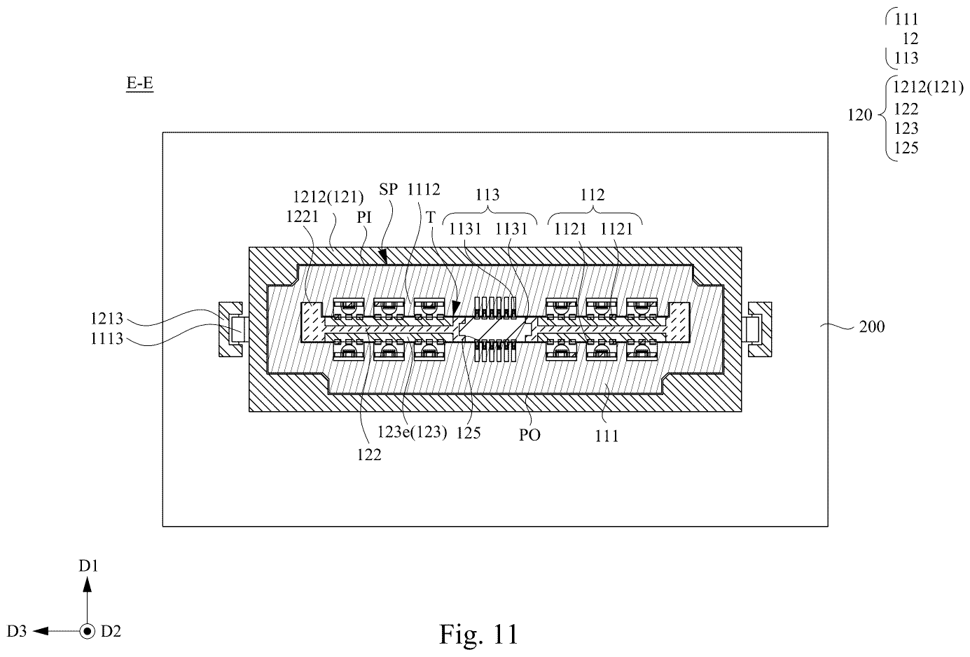

Reference is made to FIGS. 9-11. FIG. 9 is a schematic view of a connector assembly 100 according to another embodiment of the present disclosure. FIG. 10 is a sectional view along the sectional line D-D of FIG. 9. FIG. 11 is a sectional view along the sectional line E-E of FIG. 9. In this embodiment, as shown in FIGS. 9-11, the second insulating housing 121 of the second connector 120 includes a main portion 1211 and a wall portion 1212. The plate-shaped mating piece 122 is connected with the main portion 1211 and extends from a side (the mating surface 121s) of the main portion 1211. The main portion 1211 (the mating surface 121s) is configured to at least partially abut against the first insulating housing 111 of the first connector 110. The wall portion 1212 is connected with the main portion 1211 and extended from the mating surface 121s. The wall portion 1212 at least partially surrounds the plate-shaped mating piece 122 to define an inner profile PI and a space SP (i.e., the inner profile PI and/or the space SP are surrounded by the wall portion 1212). The plate-shaped mating piece 122 is at least partially located in the space SP of the wall portion 1212. The first insulating housing 111 of the first connector 110 is configured to at least partially insert into the space SP of the wall portion 1212 and abut against the mating surface 121s of the main portion 1211. The first insulating housing 111 defines an outer profile PO. The outer profile PO and the inner profile PI are respectively and at least partially asymmetrical and match with each other. Thus, this design is more foolproof and can further prevent incorrect assembly when the second connector 120 is connected to the first connector 110. For example, at least one of the four corners of the outer profile PO (and the inner profile PI) has a recess zone. In some embodiments, the outer profile PO has a plurality of recess zones, and the recess zones can have different shapes.

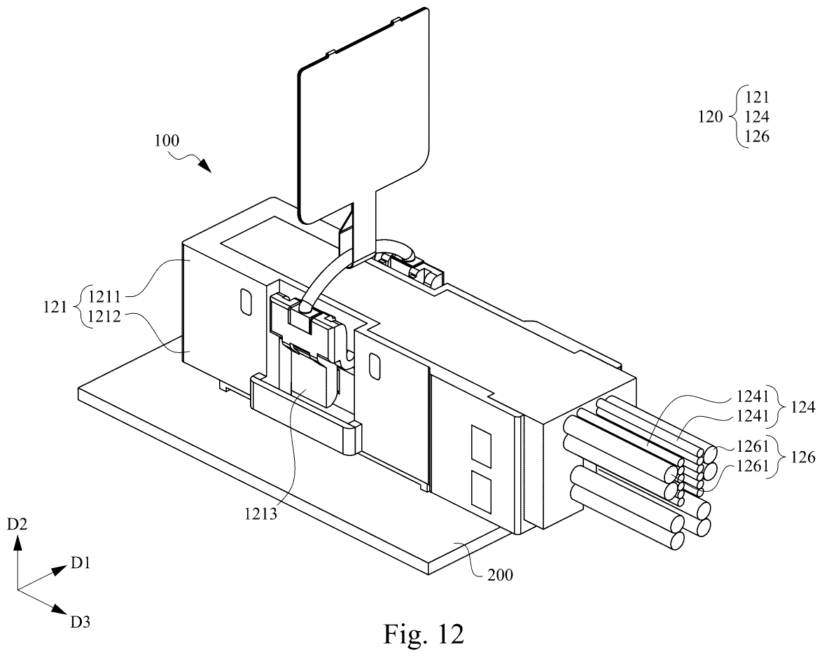

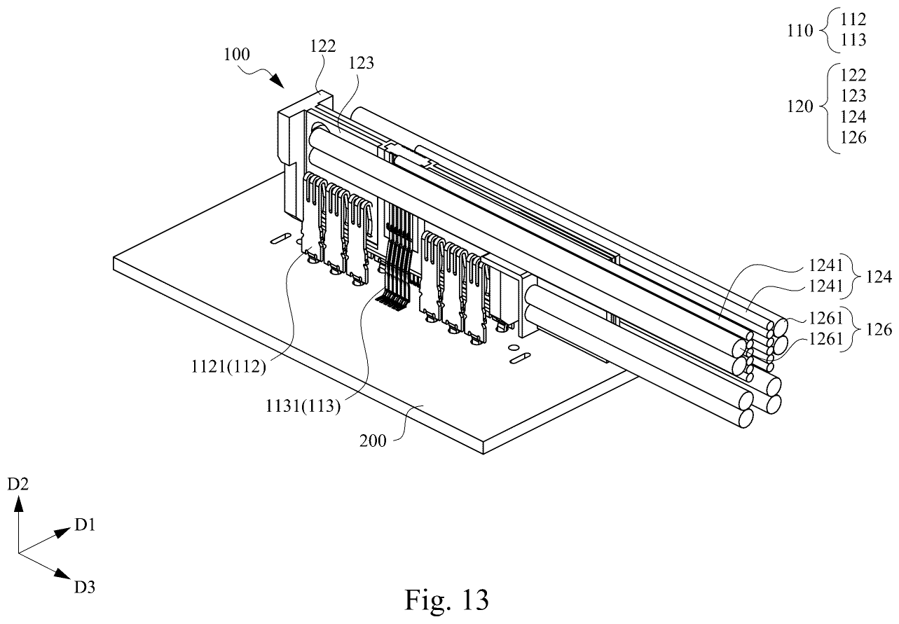

Reference is made to FIGS. 12-13. FIG. 12 is a schematic view of a connector assembly 100 according to a further embodiment of the present disclosure. FIG. 13 is a schematic view of the connector assembly 100 of FIG. 12, in which the first insulating housing 111 and the second insulating housing 121 are omitted. According to the actual situation, in this embodiment, as shown in FIGS. 12-13, the first cable set 124 and the second cable set 126 of the second connector 120 at least partially extend along the third direction D3. The plate-shaped mating piece 122 also at least partially extends along the third direction D3. The first cables 1241 of the first cable set 124 and the second cable 1261s of the second cable set 126 are at least partially disposed at two opposite sides of the plate-shaped mating piece 122. Moreover, in this embodiment, the snap-fit structures of the first connector 110 and the snap-fit structures of the second connector 120 are located at two long sides of the connectors. For example, the snapping arms 1213 shown in FIG. 12 are located at two long sides of the second connector 120. This arrangement is different from the snap-fit structures located at two short sides of the connectors in the previous embodiment(s).

In conclusion, the aforementioned embodiments of the present disclosure have at least the following advantages:
(1) Since a height of each of the mating portions of the first board end terminals along the second direction is reduced because of its folded structure, the height of the first insulating housing along the second direction relative to the printed circuit board can be effectively reduced. Thus, the overall height of the connector assembly along the second direction can be significantly reduced, which leads to a saving of space and enhances the practicality of the connector assembly.
(2) Since a profile of the cross-section of the plate-shaped mating piece matches with a profile of the opening and the avoidance space of the first insulating housing, this design is foolproof and can prevent incorrect assembly when the second connector is connected to the first connector.
(3) Since the second insulating housing of the second connector includes a main portion and a wall portion, while the outer profile of the first insulating housing of the first connector and the inner profile of the wall portion are respectively and at least partially asymmetrical and match with each other, this design is more foolproof and can further prevent incorrect assembly when the second connector is connected to the first connector.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A connector assembly, comprising:
a first connector comprising:
a first insulating housing having a slot; and
at least one first board end terminal set at least partially located in the slot and comprising a pair of first board end terminals comprising:
a connecting portion located in the slot and at least partially exposed out of the first insulating housing so as to electrically connect with a printed circuit board; and
a mating portion connected with the connecting portion and having a folded structure, the mating portion being located in the slot and spaced apart from the mating portion of another one of the first board end terminals; and
a second connector comprising:
a second insulating housing having a mating surface;
a plate-shaped mating piece extending from the mating surface along a mating direction;
at least a pair of first cable end terminals disposed at two opposite sides of the plate-shaped mating piece and electrically insulating from each other; and
a cable set comprising at least a pair of cables respectively and electrically connected with a corresponding one of the first cable end terminals and passing through and extending outwardly from the second insulating housing,
wherein the plate-shaped mating piece is configured to insert between the mating portions along the mating direction, such that the first board end terminals of the first board end terminal set are respectively and electrically connected with a corresponding one of the first cable end terminals.

2. The connector assembly of claim 1, wherein the mating portion of each of the first board end terminals comprises a plurality of elastic arms spaced apart from each other and respectively connected with the connecting portion.

3. The connector assembly of claim 2, wherein each of the elastic arms has a first end and a second end, the first end is connected with the connecting portion, the second end is a free end, a height of the second end along the mating direction is lower than or equal to a height of the first end along the mating direction.

4. The connector assembly of claim 1, wherein the first insulating housing has an opening and at least one avoidance space communicated with the opening, the opening and the avoidance space are communicated with the slot, the plate-shaped mating piece and the first cable end terminals together define a cross-section, a profile of the cross-section matches with a profile of the opening and the avoidance space, the plate-shaped mating piece is configured to at least partially pass through the opening and the avoidance space.

5. The connector assembly of claim 1, wherein each of two lateral edges of the plate-shaped mating piece is shaped as a bar column.

6. The connector assembly of claim 1, wherein each of the first cable end terminals is at least partially exposed from a surface of the plate-shaped mating piece to form an exposed portion, the exposed portion is shaped as a rectangular flat plate, a length of the exposed portion along the mating direction is shorter than a length of the exposed portion perpendicular to the mating direction.

7. The connector assembly of claim 1, wherein the second insulating housing comprises:
a main portion having the mating surface, the mating surface is configured to at least partially abut against the first insulating housing; and
a wall portion connected with the main portion and at least partially surrounding the plate-shaped mating piece to define an inner profile and a space, the plate-shaped mating piece is located in the space, the first insulating housing is configured to at least partially insert into the space and abut against the main portion, the first insulating housing defines an outer profile, the outer profile and the inner profile are respectively and at least partially asymmetrical and match with each other.

8. A board end connector, comprising:
an insulating housing having a slot and a plurality of isolating walls, the isolating walls being located at two opposite long sides of the slot to define a plurality of subsidiary slots communicated with each other; and
a plurality of first board end terminals fixed in the insulating housing and respectively located in a corresponding one of the subsidiary slots.

9. The board end connector of claim 8, wherein a width of at least one of the isolating walls is larger than a width of at least another one of the isolating walls.

10. The board end connector of claim 9, further comprising:
at least one second board end terminal, one of the isolating walls with a larger width having at least one signal slot, the second board end terminal being located in the signal slot.

11. The board end connector of claim 8, wherein the slot further defines at least one foolproof groove communicated with the subsidiary slots.

12. The board end connector of claim 8, wherein each of the first board end terminals has a connecting portion and a mating portion connected with the connecting portion, the connecting portion is configured to connect with a circuit board, the mating portion is at least partially located in a corresponding one of the subsidiary slots and comprises a plurality of elastic arms spaced apart from each other.

13. The board end connector of claim 12, wherein each of the elastic arms is a folded structure and comprises an outer subsidiary elastic arm and an inner subsidiary elastic arm, the inner subsidiary elastic arm is located at an inner side of the outer subsidiary elastic arm and configured to contact with an electric element inserting into the slot.

14. The board end connector of claim 8, wherein the insulating housing comprises:
a snap-fit structure located at two opposite short side edges of the insulating housing and configured to snap with a snapping portion of a mating connector.

15. A cable end connector, comprising:
an insulating housing having a mating surface;
a plate-shaped mating piece extending from the mating surface along a mating direction; and
a plurality of first cable end terminals disposed at two opposite sides of the plate-shaped mating piece and electrically insulating from each other,
wherein each of the first cable end terminals is at least partially exposed from a surface of the plate-shaped mating piece to form an exposed portion, the exposed portion is shaped as a rectangular flat plate, a length of the exposed portion along the mating direction is shorter than a length of the exposed portion perpendicular to the mating direction.

16. The cable end connector of claim 15, further comprising:
at least one second cable end terminal disposed on the plate-shaped mating piece and at least partially exposed from the plate-shaped mating piece, a distance between a distal end of the second cable end terminal and the mating surface being shorter than a distance between a distal end of each of the first cable end terminals and the mating surface.

17. The cable end connector of claim 16, wherein a width of the second cable end terminal perpendicular to the mating direction is shorter than a width of each of the first cable end terminals perpendicular to the mating direction.

18. The cable end connector of claim 15, wherein each of two lateral edges of the plate-shaped mating piece is shaped as a bar column.
